(19) United States
(12) Patent Application Publication
(10) Pub. No.: US 2025/0223420 A1
(43) Pub. Date: Jul. 10, 2025

(54) METHOD FOR RECOVERING RAW MATERIALS FROM POLYURETHANE PRODUCTS

(71) Applicant: Covestro Deutschland AG, Leverkusen (DE)

(72) Inventors: Dirk Hinzmann, Pulheim (DE); Verena Schiffer, Bedburg (DE); Sebastian Scherf, Leverkusen (DE); Maria Francisco Casal, Leverkusen (DE); Michelle Luedtke, Leverkusen (DE); Torsten Hagen, Dortmund (DE)

(21) Appl. No.: 18/703,454

(22) PCT Filed: Nov. 10, 2022
(86) PCT No.: PCT/EP2022/081487

§ 371 Date: Apr. 22, 2024

(30) Foreign Application Priority Data
Nov. 12, 2021 (EP) 21208004.8

(51) Int. Cl. C08J 11/28; C08G 18/48; C08G 18/82; C08J 11/06; C08J 11/14; C08J 11/16

(52) U.S. Cl. CPC C08J 11/28; C08G 18/48; C08G 18/82; C08J 11/06; C08J 11/14; C08J 11/16; C08J 2375/04

(57) ABSTRACT

The invention relates to a method for recovering raw materials from polyurethane products, said method having a chemolysis process. The chemolysis process is characterized in that the polyurethane products are reacted with (i) an aminic chemolysis reagent selected from (a) a primary or secondary organic amine, (b) an amino alcohol with a primary or secondary amino group, or (c) a mixture of (a) and (b) and (ii) water in the presence of (iii) a catalyst at a temperature ranging from 100° C. to 195° C. and at a pressure ranging from 900 mbar (abs) to 2000 mbar (abs), wherein the mass ratio of aminic chemolysis reagent and water to the polyurethane product ranges from 0.5 to 2.5, and the mass of the water ranges from 3.0% to 22% of the mass of the aminic chemolysis reagent.

The present invention relates to a method of recovering raw materials from polyurethane products, especially polyurethane foams, comprising a chemolysis. It is a feature of chemolysis that the polyurethane products are reacted with (i) an aminic chemolysis reagent selected from (a) a primary or secondary organic amine, (b) an amino alcohol having a primary or secondary amino group or (c) a mixture of (a) and (b) and (ii) water in the presence of (iii) a catalyst at a temperature of 100° C. to 195° C. and at a pressure of 900 mbar_{(abs.)} to 2000 mbar_{(abs.)}, where the mass ratio of aminic chemolysis reagent and water on the one hand and the polyurethane product on the other hand is in the range from 0.5 to 2.5, and where the mass of water is 3.0% to 22% of the mass of the aminic chemolysis reagent.

Polyurethane foams enjoy a variety of applications in industry and in everyday life. The polyurethane foams are typically divided into rigid foams and flexible foams. Common to all of these products in spite of their heterogeneity is the basic polyurethane structure, which is formed by the polyaddition reaction of a polyfunctional isocyanate and of a polyol and which in the case, for example, of a polyurethane based on a diisocyanate O═C═N—R—N═C═O and a diol H—O—R′—O—H (where R and R′ denote organic radicals) may be represented as

^{˜˜˜}[O—R′—O—(O═C)—HN—R—NH—(C═O)]^{˜˜˜}.

It is precisely the great economic success of polyurethane products that is responsible for the large amounts of polyurethane waste generated (for example from old mattresses or seating furniture) that must be sent to a sensible use. The mode of reuse that is the easiest to implement technically is that of incineration, with the heat of combustion released being utilized for other processes, examples being industrial processes. However, this does not allow raw material cycles to be completed. Another mode of reuse is called “physical recycling”, which sees polyurethane wastes mechanically comminuted and used in the production of new products. This type of recycling naturally has its limits and there has therefore been no lack of attempts to recover the basic raw materials of polyurethane production by retrocleavage of the polyurethane bonds (called “chemical recycling”). These raw materials to be recovered comprise primarily polyols (i.e., in the example above, H—O—R′—O—H). In addition, it is also possible through hydrolytic cleavage of the urethane bond to recover amines (i.e., in the example above, H₂N—R—NH₂) which can be phosgenated to afford isocyanates (in the aforementioned example to afford O═C═N—R—N═C═O) after workup. A summary of the known methods of polyurethane recycling is offered by the review article by Simón, Borreguero, Lucas and Rodríguez in Waste Management 2018, 76, 147-171 [1]. The article highlights glycolysis (see no. 2 below) as particularly significant.

A variety of chemical recycling approaches have been developed in the past. Four of these are briefly summarized as follows:
1. Hydrolysis of urethanes by reaction with water to recover amines and polyols with formation of carbon dioxide.
2. Glycolysis of urethanes by reaction with alcohols, with replacement of the polyols incorporated in the urethane groups by the alcohol used and hence release of the polyols. This process is commonly referred to in the literature as transesterification (more accurately: transurethanization). Regardless of the exact nature of the alcohol used, this mode of chemical recycling is usually dubbed glycolysis in the literature, a term that really applies only for glycol, and it would therefore be more correct to refer more generally to alcoholysis. A glycolysis may be followed by a hydrolysis. If the hydrolysis is performed still in the presence of the unchanged glycolysis mixture, this is referred to as a
3. Hydroglycolysis of urethane bonds. It is of course likewise possible to add alcohol and water from the start, in which case the above-described processes of hydrolysis and glycolysis proceed in parallel.
4. Aminolysis of urethane bonds by reaction with primary and secondary amines, with replacement of the polyols incorporated in the urethane groups by the amine used and hence release of the polyols. The urethane groups in this case are converted to urea groups. In the same way, it is also possible to cleave the R—NH—(C═O)— bonds in the urethanes and to replace the R—NH— groups with the amine used in the aminolysis, with release of the amine R—NH₂ corresponding to the isocyanate originally used. If amino alcohols having primary or secondary amino groups are used, it is of course also possible for the alcohol groups of the amino alcohol used to react with urethane bonds, such that carbamates can be formed. According to the prior art cited hereinafter, an aminolysis is followed by a hydrolysis in a separate step.

US 2016/0347927 A1 describes a chemolysis method for polyurethanes in which the chemolysis is preceded by a mechanical comminution of the polyurethane starting material to be reutilized in the moist state (wet grinding). For this purpose, the polyurethane starting material is admixed with a portion of the polyol obtained in the chemolysis. The process is started up with polyol from an earlier chemolysis process. The chemolysis can be conducted as a glycolysis, hydrolysis, methanolysis or aminolysis, preferably glycolysis. There is no description of a combination of aminolysis and hydrolysis. Suitable catalysts are standard catalysts such as sodium hydroxide, potassium hydroxide, sodium alkoxide, potassium alkoxide or mixtures of these. An emphasized advantage of the use of a polyol obtained in the chemolysis for moistening the polyurethane starting material is that it does not react with the chemolysis chemicals and therefore does not disrupt the target formulations for the chemolysis (cf., in particular, paragraphs [0021], [0073], and [0078]).

U.S. Pat. No. 3,404,103 describes a method of breakdown of a polyether polyol-based polyurethane with an amine in the presence of basic catalysts such as oxides or hydroxides of alkali metals or alkaline earth metals. This converts urethane and urea bonds in the polyurethane with release of the polyether polyol to give ureas of the amine used in the chemolysis. These ureas are cleaved under the influence of the basic catalysts to amines (namely the amine corresponding to the isocyanate used in the synthesis of the polyurethane, and the amine used for chemolysis) and carbonates (e.g. sodium carbonate). When ethanolamine (2-aminoethanol, also called monoethanolamine) is used, 2-oxazolidinone is formed as intermediate. This is cleaved under the influence of the basic catalysts to ethanolamine and carbonate.

EP 0 990 674 B1 describes a two-stage chemolysis method in which a polyurethane starting material, especially a foam (flexible or rigid foam, preferably flexible foam) is dissolved at 120° C. to 250° C. in a first stage by adding a glycol, a polyamine or an amino alcohol, and then, optionally after filtration to remove solids, hydrolyzed in an autoclave in a second stage in an autoclave with water at 200 to 320° C. at pressures of 49 to 76 bar (G) (50 to 78 kg/cm²G; see examples). For workup, water is drawn off in gaseous form, distilled off or driven out with an inert gas. The solvent is removed by distillation. Polyol and polyamine formed are separated by distillation, centrifugation or solvent extraction. Amine-containing hydrolyzate can also be reacted with alkylene oxides to give a polyol.

EP 1 142 945 A2 describes a method in which a polyurethane starting material, especially a polyurethane foam (flexible or rigid foam, preferably flexible foam) is first admixed with a polyamine and heated to 120° C. to 250° C. This forms a liquid phase containing the polyol and dissolved fractions of polyureas, and a solid phase containing undissolved fractions of polyureas. The liquid phase is then hydrolyzed in an autoclave at temperatures of 200 to 320° C. and high pressure (in the examples, at least 4.7 MPa=47 bar). The solid phase can be dissolved in further polyamine and then, optionally after removing insoluble fractions, likewise hydrolyzed. For workup, water is drawn off in gaseous form, distilled off or driven out with an inert gas. The solvent is removed by distillation. Polyol and polyamine formed are separated by distillation, centrifugation or solvent extraction. Amine-containing hydrolyzate can also be reacted with alkylene oxides to give a polyol. The description does mention that the method is also applicable to rigid foams. However, these frequently contain polyisocyanates of the diphenylmethane series (pMDI), the corresponding amines of which (polyamines of the diphenylmethane series, pMDA) that are formed in the chemolysis cannot be distilled without decomposition. There is no disclosure of a practicable method of recovering such amines.

An attempt is made by JP 2001 261584 A to solve the problem of the lack of distillability of pMDA by reacting the chemolysis product with an alkylene oxide to give a polyol. However, this procedure does not enable completion of the raw material cycles. The chemolysis methods described comprise a step of hydrolysis with water under high pressure.

EP 1 149 862 A1 describes a method in which a rigid foam is dissolved in an amine or glycol at 100° C. to 250° C. and ambient pressure, and then hydrolyzed. Suitable polyurethane foams disclosed are those that are based on tolylene diisocyanate (TDI) and/or the diisocyanates of the diphenylmethane series (mMDI). The hydrolysis is effected with super- or subcritical water. The pressure range disclosed for the hydrolysis is 100 to 250 bar. The workup is effected by fractionation. Recovered amines can be used in the new production of isocyanate or as starter for the polyol synthesis.

The aminolysis methods described have the disadvantage that there is formation of urea products and other amine-containing coproducts during the reaction of a polyurethane with an amine or amino alcohol. These amine-containing coproducts make it difficult to recover the amine corresponding to the isocyanate originally used in the preparation of the polyurethane and the polyol used in the preparation of the polyurethane. As a result, it is necessary to hydrolyze these amine-containing coproducts in a second step in a complex manner under high pressure.

EP 0 013 350 A1 describes a method of separating chemolysis products that have been obtained by hydrolysis (according to the teaching of published specification DE 2 442 387, i.e. at 100° C. to 300° C. and 5 bar to 100 bar) of polyurethanes into polyols or polyamines reusable for the production of polyurethane plastics by introducing hydrogen chloride gas into the hydrolyzate mixture that has preferably been diluted with an inert solvent, especially toluene, and filtering off the amine salt formed, whereby the precipitation by hydrogen chloride is carried out in fractions (in several partial steps).

DE 2 207 379 discloses a method of recovering polyether polyols from polyurethane plastics, in which the comminuted plastic is heated in an autoclave under direct steam pressure at about 20 atm (19.6 bar (G) to 150 to 220° C. for at least 1 hour. For workup, the reaction product thus treated can be dissolved in an organic solvent, such as toluene in particular, admixed with dilute hydrochloric acid and filtered. The remaining organic solution is concentrated by evaporation and filtered, giving the polyether polyol as residue.

According to the prior art, even the pure hydrolysis methods require high pressures, which is naturally disadvantageous.

Only a few of the chemical recycling processes known from the literature are in sustained operation on an industrial scale; many have not even reached pilot scale [1]. In view of generally increased environmental awareness and increased efforts to configure industrial processes to be as sustainable as possible—both of which are fundamentally in favor of chemical recycling—this shows clearly that the chemical recycling of polyurethane products is still by no means mature from a technical and economic point of view. Challenges exist particularly with regard to the purity of the products recovered. Moreover, an economic recycling method must ensure that the reagents used (for example alcohols, amino alcohols or amines used) can be recovered and reused (i.e. follow a closed loop) as completely as possible. Because of the large volumes of polyurethane waste generated from used polyurethane foams (for example refrigerators, hot water tanks, mattresses, seating furniture, vehicle seats and the like), the recycling of polyurethane foams is of particular importance. In addition, the polyurethane products to be reutilized usually still contain various auxiliaries and additives (stabilizers, catalysts and the like), which have to be separated from the actual target products of the recycling and disposed of in an economically viable and environmentally benign manner.

There is therefore a need for further improvements in the field of chemical recycling of polyurethane foams. In particular, it would be desirable to overcome or at least alleviate the disadvantages outlined further up in association with the aminolysis (obligatory two-stage method regime, with the second stage under high pressure) from the prior art. This is because aminolysis is a chemolysis method which is attractive per se, since it permits direct release of the amines corresponding to the isocyanates of the polyurethane product, in that these amines are substituted by more strongly Lewis-basic aminic chemolysis reagents.

Taking account of this requirement, the present invention provides a method of recovering raw materials from polyurethane products, comprising the steps of:
(A) providing a polyurethane product based on an isocyanate component and a polyol component;
(B) chemolyzing the polyurethane product in the liquid phase
   with (i) an aminic chemolysis reagent selected from (a) a primary or secondary organic amine, (b) an amino alcohol having a primary or secondary amino group or (c) a mixture of a primary or secondary organic amine (=a) and an amino alcohol having a primary or secondary amino group (=b) and (ii) water in the presence of (iii) a catalyst,
   at a temperature of 100° C. to 195° C., preferably 110° C. to 190° C., more preferably 115° C. to 160° C., and at a pressure of 900 mbar_{(abs.)} to 2000 mbar_{(abs.)}, preferably 950 mbar_{(abs.)} to 1500 mbar_{(abs.)}, more preferably 1000 mbar_{(abs.)} to 1300 mbar_{(abs.)}, and especially at ambient pressure, if required under reflux cooling,
   where the mass ratio of (1) aminic chemolysis reagent (used overall) and water (used overall) on the one hand and (2) the polyurethane product on the other hand (m(1)/m(2); i.e. [m(aminic chemolysis reagent)+m(water)]/m(polyurethane product); in which m represents mass) is in the range from 0.5 to 2.5, and where the mass of water is 3.0% to 22%, especially 4.0% to 15%, of the mass of the aminic chemolysis reagent,
   to obtain a chemolysis product;
and
(C) working up the chemolysis product to obtain (at least) an amine (corresponding to an isocyanate of the isocyanate component) and/or (at least) a polyol (corresponding to a polyol of the polyol component or formed from one such polyol in the chemolysis).

Entirely surprisingly, it has been found that the aminolysis of a polyurethane with an amine or amino alcohol in conjunction with an in situ hydrolysis (i.e. an amino hydrolysis) with an excess of water considerably simplifies the recovery of the amines and polyols by standard purification methods. The advantage of this combination of aminolysis and in situ hydrolysis by comparison with the prior art is that possible coproducts that can be formed during chemolysis (especially ureas) are hydrolyzed in situ without any great complexity, especially without the need for additional use of a pressure-rated apparatus. The method of the invention permits the performance of the chemolysis in a quasi-one-stage manner in a single reaction apparatus (but is not limited to the use of a single reaction apparatus). The product mixture present after amino hydrolysis contains the amines corresponding to the isocyanates originally used and polyols of the polyol component (or else, depending on the type of polyol component, low molecular weight (monomeric or oligomeric) degradation products thereof).

Polyurethane products in the context of the present invention are the polyaddition products (occasionally also referred to, albeit not entirely correctly, as polycondensation products) that by reaction of polyfunctional isocyanates (=isocyanate component in the polyurethane preparation) and polyols (=polyol component in the polyurethane preparation). Polyurethane products generally contain, as well as the polyurethane base structure outlined, other structures as well, for example structures having urea bonds. The presence of such structures diverging from the pure polyurethane base structure in addition to polyurethane structures does not depart from the scope of the present invention. Polyurethane products in the context of the present invention are especially polyurethane foams obtained by reaction of polyfunctional isocyanates with polyols in the presence of a blowing agent.

In the terminology of the present invention, the term isocyanates encompasses all isocyanates known to a person skilled in the art in connection with polyurethane chemistry, such as, in particular, (i) tolylene diisocyanate (TDI; prepared from tolylenediamine, TDA), (ii) methylene diphenylene diisocyanate (=“diisocyanates of the diphenylmethane series”, mMDI; prepared from methylenediphenylenediamine, mMDA), (iii) a mixture of methylene diphenylene diisocyanate (mMDI) and polymethylene polyphenylene polyisocyanate (=“polyisocyanates of the diphenylmethane series”, pMDI; prepared from polymethylenepolyphenylenepolyamine, pMDA), (iv) pentane 1,5-diisocyanate (PDI; prepared from pentane-1,5-diamine, PDA), (v) hexamethylene 1,6-diisocyanate (HDI; prepared from hexamethylene-1,6-diamine, HDA), (vi) isophorone diisocyanate (IPDI; prepared from isophoronediamine, IPDA), and (vii) xylylene diisocyanate (XDI; prepared from xylylenediamine, XDA). The expression “an isocyanate” does of course also encompass embodiments in which two or more different isocyanates (e.g. mixtures of MDI and TDI) were used in the production of the polyurethane product, unless explicitly stated otherwise, for instance by the wording “precisely one isocyanate”. The entirety of all isocyanates used in the preparation of the polyurethane product is referred to as isocyanate component (of the polyurethane product). The isocyanate component comprises at least one isocyanate. Analogously, the entirety of all polyols used in the preparation of the polyurethane product is referred to as polyol component (of the polyurethane product). The polyol component comprises at least one polyol.

In the terminology of the present invention, the term polyols encompasses all polyols known to a person skilled in the art in connection with polyurethane chemistry, such as, in particular, polyether polyols, polyester polyols, polyetherester polyols and polyethercarbonate polyols. The expression “a polyol” does of course also encompass embodiments in which two or more different polyols were used in the production of the polyurethane product. Therefore, if reference is made hereinafter, for example, to “a polyether polyol” (or “a polyester polyol” etc.), this terminology does of course also encompass embodiments in which two or more different polyether polyols (or two or more different polyester polyols etc.) were used in the production of the polyurethane product. In association with step (C), the term polyol can also represent a polyol that has been formed in the chemolysis from the polyol originally used in the production of the polyurethane product. As elucidated in detail further down, however, the polyols of the polyol component are preferably polyether polyols that can be recovered as such in the chemolysis.

Carbamates in the terminology of the present invention are any urethanes formed in step (B) by the reaction with an amino alcohol.

An amine corresponding to an isocyanate is the amine that can be phosgenated to obtain the isocyanate according to R—NH₂+COCl₂→R—N═C═O+2 HCl.

In the context of the method of the invention, water and aminic chemolysis reagent are used in superstoichiometric amounts. This means that water is used in an amount theoretically sufficient to hydrolyze all the polyurethane bonds to give amines and polyols with release of carbon dioxide. Similarly, the superstoichiometric use of aminic chemolysis reagent means that it is used in an amount theoretically sufficient to convert all the polyurethane bonds to form ureas or carbamates and polyols. This is regularly the case when the following preferred relationships between the mass ratio [m(aminic chemolysis reagent)+m(water)]/m(polyurethane product) (a) and the percentage of the mass of water based on the mass of the aminic chemolysis reagent (b) are observed:

| a = [m(aminic chemolysis | b = 100% · m(water)/ |
|---|---|
| reagent) + m(water)]/ | m(aminic chemolysis |
| m(polyurethane product) | reagent) |
| 0.5 to 1.0 | 10% to 22% |
| >1.0 to 1.5 | 7.0% to <10% |
| >1.5 to 2.0 | 4.0% to <7.0% |
| >2.0 to 2.5 | 3.0% to <4.0% |

If a is in the range from 0.5 to 1.0, a value for b in the range of 10% to 22% should be chosen; if a is in the range of >1.0 to 1.5, a value for b in the range of 7.0% to <10% should be chosen, etc.

The wording “chemolysis of the polyurethane product in the liquid phase with (i) an aminic chemolysis reagent selected from (a) a primary or secondary organic amine, (b) an amino alcohol with a primary or secondary amino group or (c) a mixture of (a) and (b) and (ii) water in the presence of (iii) a catalyst” does not necessarily imply that all the water to be used in step (B) has to be added right at the start of step (B). Instead, the invention encompasses embodiments in which no water or only a portion of the water is added at first on commencement of step (B), and the water or the rest of the water is added thereafter (all at once or preferably gradually during the reaction time). In this case, the specification of content of 3.0% to 22% of the mass of the aminic chemolysis reagent (and of course also the preferred relationships between a and b that are specified further up) relate to the amount of water added in total up to the end of the reaction time in step (B). In principle, it is also conceivable to add the aminic chemolysis reagent or a mixture of water and the aminic chemolysis reagent gradually. In any case, the stated amounts in connection with step (B) relate to the total amount added in each case up to the end of the duration of reaction in that step. Likewise encompassed by the invention are embodiments in which there is still no catalyst present at first on commencement of step (B). It is possible, for example, first to add solely aminic chemolysis reagent (without water and without catalyst) to the polyurethane product, and then to add water and catalyst, especially as an aqueous solution of the catalyst. It is of course also possible in this variant to add further water (all at once or gradually during the reaction time).

The quantitative figures in respect of water in step (B) relate to the water added as a reagent for the hydrolytic carbamate cleavage. By comparison, any amounts of water emanating from moisture that are present in any case, especially in the aminic chemolysis reagent used, are low. Moisture in the aminic chemolysis reagent used means traces of moisture as can occur on an industrial scale even in the case of proper handling and storage. It is of course possible to premix the aminic chemolysis reagent with water to be used for the hydrolytic cleavage or to wet the polyurethane product with water to be used for the hydrolytic cleavage. Such embodiments do not depart from the scope of the invention and water added in this way should of course be taken into account in the quantitative figures for step (B), i.e. the amount of water additionally to be added if required should be reduced correspondingly. If the catalyst is used in the form of an aqueous solution, the water used as solvent should likewise be taken into account in the quantitative figures for step (B), i.e. the amount of water additionally to be added if required should be reduced correspondingly.

Pressure figures in the context of the present invention are always expressed as absolute pressures, identified by a subscript “abs.” that follows the unit of pressure (for example, an absolute pressure of 900 mbar is quoted as “900 mbar_{(abs.)}”).

There will initially follow a brief summary of various possible embodiments of the invention:

In a first embodiment of the invention, which may be combined with all other embodiments, the polyurethane product in step (B)
(I) is admixed first with (1) the aminic chemolysis reagent, but not yet with the water, or (2) the aminic chemolysis reagent and a first portion of the water, and then
(II) the water (1) or a second portion of the water (2) is added, especially only after the polyurethane product has gone into solution.

It is possible here for the catalyst to be added already in step (I), which is preferred. It is alternatively possible to add the catalyst to the polyurethane product only in step (II), especially as an aqueous catalyst solution and especially only after the polyurethane product has gone into solution.

In a second embodiment of the invention, which is a particular configuration of the first embodiment, in step (II), the water (1) or the second portion of the water (2) is added continuously or in portions such that the temperature of the liquid phase during step (II) differs by a maximum of 20° C., preferably by a maximum of 15° C., more preferably by a maximum of 10° C., even more preferably by a maximum of 5.0° C. and very exceptionally preferably by a maximum of 1.0° C. from the temperature of the liquid phase in step (I).

In a third embodiment of the invention, which is a particular configuration of the first and second embodiments, in (1) (2), the first portion of the water is up to 4.0%, especially 2.0% to 4.0%, of the mass of the water added overall in step (B) (i.e. in (I) and (II) together).

In a fourth embodiment of the invention, which can be combined with all other embodiments, the aminic chemolysis reagent (a) is an aliphatic primary or secondary organic amine, (b) an aliphatic amino alcohol having a primary or secondary amino group or (c) a mixture of the two.

In a fifth embodiment of the invention, which can be combined with all other embodiments, especially the fourth embodiment, the primary or secondary organic amine (a) is a monoamine, a diamine or a mixture of a monoamine and a diamine.

In a sixth embodiment of the invention, which can be combined with all other embodiments, the aminic chemolysis reagent is selected from ethanolamine, N-methylethanolamine, 3-amino-1-propanol, ethylene-1,2-diamine, 1,4-diaminobutane, hexamethylene-1,6-diamine or a mixture of two or more of the aforementioned aminic chemolysis reagents.

In a seventh embodiment of the invention, which can be combined with all other embodiments, the catalyst is selected from a hydroxide (especially an alkali metal or alkaline earth metal hydroxide), a carboxylate (especially acetate) (especially an alkali metal or alkaline earth metal carboxylate (especially acetate)), a tin compound (especially dibutyltin dilaurate or tin(II) octoate [=tin(II) 2-ethylhexanoate]), a zinc compound (especially zinc acetate), a carbonate (especially an alkali metal or alkaline earth metal carbonate), an orthophosphate (especially an alkali metal or alkaline earth metal orthophosphate), a monohydrogenorthophosphate (especially an alkali metal or alkaline earth metal monohydrogenorthophosphate), a metaphosphate (especially an alkali metal or alkaline earth metal metaphosphate) or a mixture of two or more of the aforementioned catalysts.

In an eighth embodiment of the invention, which is a particular configuration of the seventh embodiment, the catalyst is selected from a carbonate (especially an alkali metal or alkaline earth metal carbonate), an orthophosphate (especially an alkali metal or alkaline earth metal orthophosphate), a monohydrogenorthophosphate (especially an alkali metal or alkaline earth metal monohydrogenorthophosphate) or a mixture of two or more of the aforementioned catalysts.

In a ninth embodiment of the invention, which can be combined with all other embodiments, especially the seventh and eighth embodiments, the mass ratio of catalyst and polyurethane product is in the range from 0.001 to 0.035.

In a tenth embodiment of the invention, which can be combined with all other embodiments, step (II) is conducted in a chemolysis reactor selected from a stirred tank (especially a jacketed stirred tank), a tubular reactor or a combination of the two.

In an eleventh embodiment of the invention, which can be combined with all other embodiments, step (C) comprises a liquid-liquid extraction with an extractant and phase separation into a first product phase comprising the amine or a salt of the amine and a second product phase comprising the polyol.

In a twelfth embodiment of the invention, which is a particular configuration of the eleventh embodiment, the liquid-liquid extraction is preceded by a distillative separation of the aminic chemolysis reagent from the chemolysis product.

In a thirteenth embodiment of the invention, which is a particular configuration of the eleventh and twelfth embodiments, the ratio of the masses of the mixture to be extracted (=the chemolysis product or the product mixture) and the extractant in the liquid-liquid extraction is 0.5 to 1.5, preferably 0.7 to 1.3, more preferably 0.9 to 1.1 and especially 1.0.

In a fourteenth embodiment of the invention, which is a particular configuration of the eleventh to thirteenth embodiments, the isocyanate component comprises tolylene diisocyanate (TDI), and the extractant comprises (i) an organic solvent selected from an (aliphatic or aromatic) hydrocarbon or a halogen-substituted, especially chlorinated, (aliphatic or aromatic) hydrocarbon and (ii) water.

In a fifteenth embodiment of the invention, which is a particular configuration of the fourteenth embodiment, the amine, tolylenediamine (TDA) in this embodiment, is distilled out of the first product phase.

In a sixteenth embodiment of the invention, which is a particular configuration of the fourteenth and fifteenth embodiments, the second product phase is purified by distillation and/or stripping to obtain the polyol.

In a seventeenth embodiment of the invention, which is a particular configuration of the fourteenth to sixteenth embodiments, the organic solvent is selected from cyclohexane, toluene, methylene chloride, chloroform, a chlorinated aromatic hydrocarbon (such as chlorobenzene or ortho-dichlorobenzene in particular) or a mixture of two or more of the aforementioned organic solvents.

In an eighteenth embodiment of the invention, which is a particular configuration of the fourteenth to seventeenth embodiments, the liquid-liquid extraction is conducted at a temperature of 20° C. to 40° C., preferably 25° C. to 35° C., and especially at ambient temperature.

In a nineteenth embodiment of the invention, which is a further particular configuration of the eleventh to thirteenth embodiments, the isocyanate component comprises methylene diphenylene diisocyanate (“monomeric MDI” having two isocyanate groups; mMDI) or a mixture of methylene diphenylene diisocyanate and polymethylene polyphenylene polyisocyanate (“polymeric MDI” having three or more isocyanate groups; pMDI), and the extractant comprises (i) an organic solvent selected from an (aliphatic or aromatic) hydrocarbon or a halogen-substituted, especially chlorinated, (aliphatic or aromatic) hydrocarbon and (ii) hydrochloric acid.

In a twentieth embodiment of the invention, which is a particular configuration of the nineteenth embodiment, the organic solvent (i) comprises a halogen-substituted, especially chlorinated, (aliphatic or aromatic) hydrocarbon.

In a twenty-first embodiment of the invention, which is a particular configuration of the twentieth embodiment, the halogen-substituted hydrocarbon is selected from methylene chloride, chloroform, a chlorinated aromatic hydrocarbon (such as chlorobenzene or ortho-dichlorobenzene in particular) or a mixture of two or more of the aforementioned halogen-substituted hydrocarbons.

In a twenty-second embodiment of the invention, which is a particular configuration of the nineteenth to twenty-first embodiments,
(III) the first product phase is extracted with a halogen-substituted hydrocarbon, followed by
(IV) phase separation into a first aqueous phase and a first organic phase,
(V) neutralization of the first aqueous phase and phase separation into a second aqueous phase and a second organic phase, and
(VI) distillation and/or stripping of the second organic phase to obtain the amine, in this embodiment methylenediphenylenediamine (“monomeric MDA” having two amino groups; mMDA) or a mixture of methylenediphenylenediamine and polymethylenepolyphenylenepolyamine (“polymeric MDA” having three or more amino groups; pMDA).

In a twenty-third embodiment of the invention, which is a particular configuration of the nineteenth to twenty-second embodiments, the second product phase is purified by distillation and/or stripping to obtain the polyol.

In a twenty-fourth embodiment of the invention, which is a particular configuration of the nineteenth to twenty-third embodiments, the liquid-liquid extraction is conducted at a temperature of 20° C. to 60° C., preferably 40° C. to 55° C., more preferably at 47° C. to 53° C. and especially at 50° C.

In a twenty-fifth embodiment of the invention, which can be combined with all other embodiments, the polyurethane product is a polyurethane foam.

The embodiments outlined briefly above and further possible configurations of the invention are more particularly elucidated hereinbelow. All the above-described embodiments and the further configurations of the invention described below are mutually and collectively combinable as desired unless the opposite is clearly apparent from the context to a person skilled in the art or is expressly stated.

### Providing the Polyurethane Product for Chemical Recycling

Step (A) of the method of the invention comprises providing the polyurethane product to be chemically recycled in preparation for the chemolysis.

This may in principle be any kind of polyurethane product; however, polyurethane foams are preferred. In the case of polyurethane foams, it is possible to process either flexible foams (for example from old mattresses, cushioned furniture or car seats) or rigid foams (for example from insulations) by the method of the invention (see also the examples in this regard). Such polyurethane foams are typically produced using pentane, dichloromethane and/or carbon dioxide as blowing agents.

In addition, preference is given to those polyurethane products which, with regard to the isocyanate component, are based on an isocyanate selected from (i) tolylene diisocyanate (TDI), (ii) methylene diphenylene diisocyanate (=“diisocyanates of the diphenylmethane series”, mMDI; prepared from methylenediphenylenediamine, mMDA), (iii) a mixture of methylene diphenylene diisocyanate (mMDI) and polymethylene polyphenylene polyisocyanate (=“polyisocyanates of the diphenylmethane series”, pMDI; prepared from polymethylenepolyphenylenepolyamine, pMDA), (iv) pentane 1,5-diisocyanate (PDI), (v) hexamethylene 1,6-diisocyanate (HDI), (vi) isophorone diisocyanate (IPDI), (vii) xylylene diisocyanate (XDI) or (viii) mixtures of two or more of the aforementioned isocyanates. Particular preference is given to polyurethane foams that are based, with regard to the isocyanate component, either on TDI or on MDI.

With regard to the polyol component, preference is given to polyurethane foams that are based on a polyol selected from a polyether polyol, a polyester polyol, a polyetherester polyol, a polyethercarbonate polyol, a polyacrylate polyol or a mixture of two or more of the aforementioned polyols. The polyol component is preferably a polyether polyol. More preferably, the polyol component is a polyether polyol (i.e. does not contain any polyols other than polyether polyols; but a mixture of two or more different polyether polyols is encompassed and does not depart from the scope of this embodiment). The polyether polyol may also be one that is filled with a styrene-acrylonitrile copolymer (SAN copolymer). It is one of the advantages of the invention that it also applicable to such polyol components. The challenge in the chemolysis of polyurethane foams having a polyol component based on SAN copolymer-filled polyether polyols is that the SAN copolymer is released as finely divided polymer particles during the chemolysis. This applies regardless of the chemolysis method chosen. The SAN polymer present as finely divided polymeric particles in the reaction mixture leads to problems in the subsequent separation by extractive methods for example. Furthermore, due to the fineness of the polymer particles, filtration is hardly possible since the filter quickly becomes blocked and further removal is no longer possible. The advantage of the hydroaminolysis of the invention is that, after it has been released from the polyether polyol, the SAN polymer is partly converted back to a soluble form by the hydrolysis step, and hence the reaction mixture can be worked up without difficulty by extraction after the chemolysis.

Most preferably, the polyurethane product is one wherein the isocyanate component is either tolylene diisocyanate (TDI) or methylene diphenylene diisocyanate (mMDI) or a mixture of mMDI and polymethylene polyphenylene polyisocyanate (pMDI), and wherein the polyol component contains a polyether polyol (and in particular is a polyether polyol, i.e. does not contain any further polyols other than polyether polyols, although a mixture of two or more different polyether polyols is included and does not depart from the scope of this embodiment).

Preferably, even step (A) comprises preparatory steps for the cleavage of the urethane bonds in step (B). These are especially mechanical comminution of the polyurethane products. Such preparatory steps are known to a person skilled in the art; reference is made by way of example to the literature cited in [1]. Depending on the characteristics of the polyurethane product, it may be advantageous to “freeze” it before the mechanical comminution in order to facilitate the comminuting operation; this is especially true of polyurethane foams.

It is also conceivable to conduct the above-described preparatory steps at a site spatially separate from the site of the chemolysis. In that case, the prepared polyurethane product is transferred into suitable transport vehicles, for example silo vehicles, for further transport. For further transport the prepared polyurethane product, especially in the case of a polyurethane foam, may additionally be compressed to achieve a higher mass-to-volume ratio. The polyurethane product is then transferred into the reaction apparatus provided for the chemolysis at the location of the chemolysis. It is also conceivable to connect the transport vehicle used directly to the reaction apparatus.

### Chemolysis of the Polyurethane Product to Obtain the Chemolysis Product

Step (B) of the method of the invention includes the chemolysis of the polyurethane product provided in step (A).

The chemolysis is preferably carried out in the absence of oxygen. This means that the reaction is carried out in an inert gas atmosphere (especially in a nitrogen, argon or helium atmosphere). It is also preferable to free the chemolysis reagents used (water and aminic chemolysis reagent) of oxygen by inert gas saturation.

As already mentioned, it is unnecessary to add all the water right at the start of step (B). In particular, it is also possible, in step (B),
(I) to first admix the polyurethane product with (1) the aminic chemolysis reagent, but not yet with the water, or (2) the aminic chemolysis reagent and a first portion of the water, and only then
(II) to add the water (1) or a second portion of the water (2), especially only after the polyurethane product has gone into solution.

It is possible here for the catalyst to be added already in step (I), which is preferred. It is alternatively possible to add the catalyst to the polyurethane product only in step (II), especially as an aqueous catalyst solution and especially only after the polyurethane product has gone into solution. The expression “gone into solution” in this connection does not necessarily imply the presence of a “true” solution in the sense of a completely homogeneous mixture. It may quite possibly be the case that there is a “cloudy” solution of the polyurethane product; this does not leave the scope of the present invention.

In the course of performance of step (B) in steps (I) and (II), it is especially preferable, in step (II), to add the water (1) or the second portion of the water (2) continuously or in portions such that the temperature of the liquid phase during step (II) differs by a maximum of 20° C., preferably by a maximum of 15° C., more preferably by a maximum of 10° C., even more preferably by a maximum of 5.0° C. and very exceptionally preferably by a maximum of 1.0° C. from the temperature of the liquid phase in step (I). What this achieves is that the temperature is always high enough to assure progression of the chemolysis. If a portion of the water is already added at the start of the chemolysis (=(I)(2)), it is preferable that the first portion of the water is up to 4.0%, especially 2.0% to 4.0%, of the mass of the total amount of water added in step (B) (i.e. in (I) and (II) together).

Irrespective of the exact configuration of step (B), it is preferable to use aliphatic aminic chemolysis reagents. The aminic chemolysis reagent is thus preferably (a) an aliphatic primary or secondary organic amine, (b) an aliphatic amino alcohol having a primary or secondary amino group or (c) a mixture of the two.

The primary or secondary amines are preferably mono- and/or diamines. Ethanolamine (2-aminoethanol), N-methylethanolamine, 3-amino-1-propanol, ethylene-1,2-diamine, 1,4-diaminobutane, hexamethylene-1,6-diamine or a mixture of two or more of these are particularly preferred as aminic chemolysis reagents.

Catalysts suitable with preference for the performance of the chemolysis are hydroxides (especially alkali metal or alkaline earth metal hydroxides), carboxylates (especially acetates) (especially alkali metal or alkaline earth metal carboxylates (especially acetates)), tin compounds (especially dibutyltin dilaurate or tin(II) octoate [=tin(II) 2-ethylhexanoate]), zinc compounds (especially zinc acetate), carbonates (especially alkali metal or alkaline earth metal carbonates), orthophosphates (especially alkali metal or alkaline earth metal orthophosphates), monohydrogenorthophosphates (especially alkali metal or alkaline earth metal monohydrogenorthophosphates), metaphosphates (especially alkali metal or alkaline earth metal metaphosphates) or a mixture of two or more of the aforementioned catalysts. Particular preference is given to carbonates (especially alkali metal or alkaline earth metal carbonates), orthophosphates (especially alkali metal or alkaline earth metal orthophosphates), monohydrogenorthophosphates (especially alkali metal or alkaline earth metal monohydrogenorthophosphates) or a mixture of two or more of the aforementioned catalysts. The mass ratio of catalyst and polyurethane product is preferably in the range from 0.001 to 0.035.

Suitable reaction apparatuses (=chemolysis reactors) for the performance of the chemolysis are stirred tanks and tubular reactors, for example. Stirred tanks are preferably designed as heatable jacketed stirred tanks. These especially have a base outlet and a stirrer controllable by means of a drive, an input port for filling with solids, feed tubes for liquids connected to metering pumps, and a sparging tube for protective gas.

As already mentioned, the method of the invention permits the performance of the chemolysis in step (B) in a single reaction apparatus. In the embodiment outlined further up comprising partial steps (I) and (II), it may be advisable, however, especially in the case of a continuous method regime, to conduct steps (I) (“dissolving” the polyurethane product in aminic chemolysis reagent, optionally in the presence of a portion of the water) and (II) (adding the water or a portion thereof) in two successive reaction apparatuses which then in their totality make up the chemolysis reactor. The abovementioned preferred reaction apparatuses may also be used here, although it is also possible that a stirred tank is used in step (I) and a tubular reactor in step (II) (or vice versa).

### Workup of the Chemolysis Product

Step (B) affords a chemolysis product containing
(at least) an amine corresponding to an isocyanate of the isocyanate component,
(at least) a polyol (from the polyol component or formed from the latter in step (B)),
(superstoichiometrically used and therefore incompletely converted) aminic chemolysis reagent and
(superstoichiometrically used and therefore incompletely converted) water.

In step (C), this chemolysis product is worked up to recover raw materials. This recovers (at least) one amine, (at least) one polyol or both.

It is preferable that step (C) comprises a liquid-liquid extraction with an extractant and phase separation into a first product phase comprising the amine or a salt of the amine and a second product phase comprising the polyol (separation of amine and polyol).

In a particular configuration of this embodiment, which is advantageous especially when the polyurethane product is an MDI-based polyurethane product or is a polyurethane product with a mixture of different polyols in the parent polyol component, the liquid-liquid extraction is preceded by a distillative separation of the aminic chemolysis reagent from the chemolysis product. After the aminic chemolysis reagent has been separated off, what remains is a product mixture which is subjected to the liquid-liquid extraction. In each case, the mass ratio of the mixture to be extracted (i.e. the chemolysis product or the product mixture obtained in the distillative removal of the aminic chemolysis reagent) and the extractant in the liquid-liquid extraction is preferably 0.5 to 1.5, more preferably 0.7 to 1.3, even more preferably 0.9 to 1.1 and especially 1.0. It will be self-evident to the person skilled in the art that this separation need not necessarily proceed perfectly in the sense that all amine goes into the first product phase and all polyol into the second product phase. If, for example, because of the prevailing solubility equilibria, small amounts of the amine get into the second product phase (or small amounts of the polyol into the first product phase), this of course does not leave the scope of the present invention.

A preferred field of use for the method of the invention is the recycling of tolylene diisocyanate-based (TDI-based) polyurethane products, preferably of TDI-based polyurethane foams, especially flexible foams. In this case, it is preferable that the extractant comprises
(i) an organic solvent selected from an (aliphatic or aromatic) hydrocarbon or a halogen-substituted, especially chlorinated, (aliphatic or aromatic) hydrocarbon and
(ii) water.

A suitable organic solvent is especially cyclohexane, toluene, methylene chloride, chloroform, a chlorinated aromatic hydrocarbon (such as, in particular, chlorobenzene or ortho-dichlorobenzene) or a mixture of two or more of the aforementioned organic solvents. The liquid-liquid extraction is preferably conducted at a temperature of 20° C. to 40° C., preferably 25° C. to 35° C., and especially at ambient temperature.

The amine, i.e. in this case tolylenediamine (TDA), can be obtained from the first product phase by distillation to obtain TDA as the purified distillate. The distillation of TDA is sufficiently well known in the specialist field and therefore need not be described here in detail.

The second product phase is preferably purified by distillation and/or stripping to obtain the polyol. In the stripping, a stripping gas (such as, in particular, nitrogen or steam, preferably nitrogen) is used. A distillation is preferably performed in an evaporator selected from falling-film evaporators, thin-film evaporators, flash evaporators, rising-film evaporators, natural circulation evaporators, forced circulation evaporators or tank evaporators. It is particularly preferable for the distillation to be followed by a stripping operation with steam.

A further preferred field of use for the method of the invention is the recycling of MDI-based polyurethane products, i.e. those polyurethane products wherein the isocyanate component is based on methylene diphenylene diisocyanate (“monomeric MDI” having two isocyanate groups; mMDI) or—preferably—a mixture of methylene diphenylene diisocyanate and polymethylene polyphenylene polyisocyanate (“polymeric MDI” having three or more isocyanate groups; pMDI). Particular mention should be made here of MDI-based polyurethane foams, especially rigid foams. MDI-based polyurethane foams are preferably based on a mixture of mMDI and pMDI.

Irrespective of whether the MDI-based polyurethane product is a foam or not and also irrespective of whether the isocyanate component used in the production of the polyurethane product comprises solely mMDI or a mixture of mMDI and pMDI, it is preferable that the extractant comprises
(i) an organic solvent selected from an (aliphatic or aromatic) hydrocarbon or a halogen-substituted, especially chlorinated, (aliphatic or aromatic) hydrocarbon and
(ii) hydrochloric acid.

A suitable organic solvent is especially a halogen-substituted, especially chlorinated, (aliphatic or aromatic) hydrocarbon. Particular mention should be made here of methylene chloride, chloroform, chlorinated aromatic hydrocarbons (such as, in particular, chlorobenzene or ortho-dichlorobenzene) or a mixture of two or more of the aforementioned halogen-substituted hydrocarbons. The liquid-liquid extraction is preferably conducted at a temperature of 20° C. to 60° C., preferably 40° C. to 55° C., more preferably 47° C. to 53° C. and especially at 50° C.

The hydrochloric acid should especially be used in a sufficient amount to be able to protonate all the primary or secondary amino groups present (molar ratio of HCl to the sum total of primary and secondary amino groups 1:1 or greater). The proportion of primary and secondary amino groups can be determined via the amine value.

The amine value indicates how many mg of potassium hydroxide are required to neutralize the free organic amines present in 1 g of substance. This covers primary, secondary and tertiary amino groups. The amino groups are weak bases. The solvent used is concentrated acetic acid (glacial acetic acid, 99% to 100%). The amine is protonated by the solvent and thus converted to the corresponding acid, which is now present as an ion pair with the deprotonated acid of the glacial acetic acid. The mixture is subsequently titrated with 0.1 molar perchloric acid as the titrant, in the course of which the perchloric acid displaces the anion of the solvent (glacial acetic acid). The perchloric acid consumed in the process is equated to the consumption of potassium hydroxide. The amine number is typically reported in milligrams of KOH per gram of analyzed sample and is calculated as follows:

$$\frac{AZ}{mg ( KOH ) \cdot {g}^{- 1}} = \frac{\frac{V}{ml} \cdot [ {b}_{i} / ( mol \cdot {l}^{- 1} ) ] \cdot [ M ( KOH ) / ( g \cdot {mol}^{- 1} ) ] \cdot f}{\frac{m}{g}}$$

in which
   AZ represents the amine value,
   Vrepresents the volume of perchloric acid solution consumed,
   m represents the mass of the titrated sample,
   M (KOH) represent the molar mass of KOH (56.11 g·mol⁻¹),
   bᵢ represents the molarity of the perchloric acid solution and
   f represents the dimensionless factor (titer) of the perchloric acid solution.

In the case of MDI-based polyurethane products, the workup of the first product phase to obtain the amine, i.e. in this case to obtain methylenediphenylenediamine (“monomeric MDA” having two amino groups; mMDA) or a mixture of methylenediphenylenediamine and polymethylenepolyphenylenepolyamine (“polymeric MDA” having three or more amino groups; pMDA), in a particularly preferred embodiment comprises the following further steps:
(I) extraction of the first product phase with a halogen-substituted hydrocarbon, followed by
(II) phase separation of the process product of the extraction into a first aqueous phase (containing the hydrochloride of mMDA or of mMDA and pMDA) and a first organic phase,
(III) neutralization of the first aqueous phase and phase separation into a second aqueous phase (containing the salts formed in neutralization) and a second organic phase (containing mMDA, or mMDA and pMDA), and
(IV) distillation and/or stripping of the second organic phase to obtain the amine, i.e. in this embodiment mMDA or a mixture of mMDA and pMDA.

The workup of the second product phase to obtain the polyol, as in the case of the TDI-based polyurethane products, is preferably effected by distillation and/or stripping, where preferred configurations are the same as described above.

The examples which follow are intended to further illustrate the invention.

### EXAMPLES

### Example 1

An initial charge of 200 g of ethanolamine and 2 g of sodium carbonate in a 1000 ml 4-neck flask fitted with a stirrer, thermometer and cooling assembly is heated to 150° C. under nitrogen. 200 g of rigid PU foam having the composition reported in table 1 is added and dissolved while stirring. After dissolution, the mixture was stirred at 150° C. for 2 hours, and then 17 g of water was added within a period of 30 minutes such that the reaction temperature did not fall below 150° C. After addition of water, stirring was continued at 150° C. for 3 hours. Subsequently, ethanolamine was distilled off at 150° C. and <20 mbar.

TABLE 1
Formulation of the rigid polyurethane foam converted
in example 1 (figures are parts by weight)

| | |
|---|---|
| Sucrose- and sorbitol-started polyether (1) | 25 |
| o-TDA-started polyether (1) | 9.3 |
| Propylene glycol-started polyether (1) | 2.6 |
| Water | 0.9 |
| Siloxane additive (2) | 0.7 |
| Amine catalysts (3 + 4) | 0.7 |
| Cyclopentane (5) | 5.4 |
| Desmodur 44V20L (6) | 55.4 |
| Index (7) | 108 |

(1) Polyether polyols from Covestro Deutschland AG
(2) Polyethersiloxane additive from Evonik AG
(3) Amine catalyst from Covestro Deutschland AG
(4) Amine catalyst from Evonik AG
(5) Physical blowing agent
(6) Desmodur 44V20L is a polymeric diphenylmethane diisocyanate from Covestro Deutschland AG
(7) Ratio of NCO to OH groups

### Examples 3 to 7

Further experiments were performed using different amino alcohols and amines than in the example 1 but otherwise the same procedure. The chemolysis reagents used are compiled in table 2.

TABLE 2
Further experiments analogous to example
1 with other amino alcohols and amines.

| Aminic | | Ex. 3 | | Ex. 5 | | |
|---|---|---|---|---|---|---|
| chemolysis | Ex. 2 | (compar- | Ex. 4 | (compar- | Ex. 6 | Ex. 7 |
| reagent | (inv.) | ative) | (inv.) | ative) | (inv.) | (inv.) |
| 3-Amino-1- | 200 g | | | | | |
| propanol | | | | | | |
| N,N- | | 200 g | | | | |
| Dimethylethanol- | | | | | | |
| amine | | | | | | |
| N-Methylethanol- | | | 200 g | | | |
| amine | | | | | | |
| N,N- | | | | 200 g | | |
| Diethylethanol- | | | | | | |
| amine | | | | | | |
| Ethylene-1,2- | | | | | 200 g | |
| diamine | | | | | | |
| Butane-1,4- | | | | | | 200 g |
| diamine | | | | | | |

### Example 8

Example 8 corresponds to example 1, except that ethanolamine, water and catalyst formed a direct initial charge and, after the rigid PU foam from table 1 had been dissolved, the reaction was conducted at 150° C. for 4 hours.

### Example 9

Example 9 corresponds with example 8, except that catalyst and water were added only after the foam from table 1 had been dissolved in ethanolamine. The reaction was then conducted at 150° C. for 4 h.

### Example 10: (Noninventive: Amount of Water Too Small)

An initial charge of 150 g of ethanolamine and 3 g of a 50% aqueous sodium hydroxide solution in a 500 ml 4-neck flask fitted with a stirrer, thermometer and cooling assembly is heated to 150° C. under nitrogen. 150 g of rigid PU foam having the composition reported in table 1 is added and dissolved while stirring. After the dissolution, the mixture was stirred at 150° C. for 4 hours. Subsequently, ethanolamine was distilled off at 150° C. and <20 mbar.

### Example 11 (Inventive: Further Addition of Water Compared to Example 10)

An initial charge of 150 g of ethanolamine and 3 g of a 50% aqueous sodium hydroxide solution in a 500 ml 4-neck flask fitted with a stirrer, thermometer and cooling assembly is heated to 150° C. under nitrogen. 150 g of rigid PU foam having the composition reported in table 1 is added and dissolved while stirring. After dissolution, the mixture was stirred at 150° C. for 2 hours, and then 14 g of water was added within a period of 30 minutes such that the reaction temperature did not fall below 150° C. After addition of water, stirring was continued at 150° C. for 3 hours. Subsequently, ethanolamine was distilled off at 150° C. and <20 mbar.

TABLE 3
Sum total of 4,4- and 2,4-MDA, measured by
HPLC (calibrated against external standard)

| | Yield of 2,4′- | | |
|---|---|---|---|
| | and 4,4′-MDA in | | |
| | % of theory | Chemolysis reagent | Catalyst |
| Ex. 1 | 72.5 | Ethanolamine | Na₂CO₃ |
| Ex. 2 | 50.0 | 3-Amino-1-propanol | Na₂CO₃ |
| Ex. 3 | 23.0 | N,N- | Na₂CO₃ |
| (comparative) | | Dimethylethanolamine | |
| Ex. 4 | 83.0 | N-Methylethanolamine | Na₂CO₃ |
| Ex. 5 | 44.0 | N,N- | Na₂CO₃ |
| (comparative) | | Diethylethanolamine | |
| Ex. 6 | 73.0 | Ethylene-1,2-diamine | Na₂CO₃ |
| Ex. 7 | 51.0 | Butane-1,4-diamine | Na₂CO₃ |
| Ex. 8 | 74.5 | Ethanolamine | Na₂CO₃ |
| Ex. 9 | 70.0 | Ethanolamine | Na₂CO₃ |
| Ex. 10 | 73.0 | Ethanolamine | NaOH |
| (comparative) | | | |
| Ex. 11 | 76.0 | Ethanolamine | NaOH |

The results show that ethanolamine and N-methylethanolamine are the most effective with regard to urethane cleavage and release of MDA and (P) MDA. N,N-Disubstituted (tertiary) ethanolamines where the amino group cannot serve for chemical cleavage of urethane bonds (examples 3 and 5) give considerably worse results.

### Example 12

Further amino hydrolysis experiments were conducted on a flexible foam. Table 4 contains the flexible foam formulation used.

TABLE 4
Formulation of flexible polyurethane foam reacted
in example 12 (reported in parts by weight)

| | |
|---|---|
| Arcol 1108 polyol (1) | 72.4 |
| Water | 1.8 |
| Tegostab BF 2370 (2) | 0.9 |
| Dabco T9 (3) | 0.1 |
| Niax A1 (4) | 0.06 |
| TDI 80 (5) | 24.7 |
| Index (6) | 108 |

(1) Polyether polyol from Covestro Deutschland AG
(2) Polyethersiloxane additive from Evonik AG
(3) DABCO T9 is a tin octoate catalyst from Evonik AG
(4) Niax A1 is an amine catalyst from Momentive Performance Materials
(5) TDI 80 is a tolylene diisocyanate from Covestro Deutschland AG
(6) Ratio of NCO to OH groups

An initial charge of 300 g of ethanolamine and 3 g of sodium carbonate in a 1000 ml 4-neck flask fitted with a stirrer, thermometer and cooling assembly is heated to 150° C. under nitrogen. 300 g of flexible PU foam having the composition reported in table 4 was added and dissolved while stirring. After dissolution, the mixture was stirred at 150° C. for 2 hours, and then 18 g of water was added within a period of 30 minutes such that the reaction temperature does not fall below 150° C. After addition of water, stirring is continued at 150° C. for 3 hours.

### Example 13: Recovery of the r-Polyether Polyol

The polyether polyol was recovered as follows from the reaction mixture obtained in example 12 (“r-polyether polyol”):

The reaction mixture was admixed with 3 parts by weight of cyclohexane and vigorously homogenized. In a separating funnel, the mixture is separated into two phases: an organic cyclohexane-polyether phase (containing small proportions of TDA and ethanolamine) and an ethanolamine-TDA phase. The organic phase was separated off, the solvent was removed by distillation, and the r-polyol was thus recovered.

The OH number of the r-polyether polyol was 64.8 mg (KOH)/g, and the amine value 16.9 mg (KOH)/g. On a laboratory scale, it is not always possible to fully distill off the ethanolamine used in excess and the TDA released in the chemolysis, which is reflected in the amine value of 16.9 mg (KOH)/g. The OH number of the r-polyether polyol corrected by the amine value is 47.9 mg (KOH)/g, and is therefore within the range from 46 to 50 mg (KOH)/g specified for fresh Arcol 1108. It can be assumed that the amines will be separated off significantly better on an industrial scale with efficient distillation apparatuses.

The OH number (OHN) of the r-polyether polyol recovered was determined by titrimetry. This involves acetylating the sample with acetic anhydride in the presence of pyridine. One mole of acetic acid is formed per hydroxyl group, while the excess acetic anhydride provides two moles of acetic acid. The consumption of acetic acid is determined by titrimetry from the difference between the main value and a blank value to be performed simultaneously. The hydroxyl number is calculated as follows taking account of the consumed ml of 0.5 N potassium hydroxide solution in the main and blank tests, and also the acid number (AN) of the sample and the starting weight:

$$\frac{OHZ}{mg ( KOH ) \cdot {g}^{- 1}} = \frac{\frac{{V}_{b} - {V}_{a}}{ml} \cdot 28 , 055}{\frac{m}{g}} + \frac{SZ}{mg ( KOH ) \cdot {g}^{- 1}}$$

in which
   Vₐ represents the volume of 0.5 N potassium hydroxide solution consumed in the main test,
   V_{b} represents the volume of 0.5 N potassium hydroxide solution consumed in the blank test and
   m represents mass of the sample titrated.

The acid number was likewise determined by titrimetry. The acid number indicates how many mg of KOH is required to neutralize the free fatty acids in 1 g of fatty acid. A suitable starting weight is weighed into a glass beaker, dissolved in about 100 ml of neutralized ethanol and titrated potentiometrically to the end point with sodium hydroxide solution. The acid number is determined as follows:

$$\frac{SZ}{mg ( KOH ) \cdot {g}^{- 1}} = \frac{\frac{V}{ml} \cdot [ M ( KOH ) / ( g \cdot {mol}^{- 1} ) ] \cdot [ N / ( mol \cdot {l}^{- 1} ) ] \cdot f}{\frac{m}{g}}$$

in which
   AN represents the acid number,
   V represents the volume of sodium hydroxide solution consumed,
   M (KOH) represent the molar mass of KOH (56.11 g·mol⁻¹),
   N represents the normality of the sodium hydroxide solution,
   f represents the dimensionless factor (titer) of the sodium hydroxide solution and
   m represents the mass of the sample titrated.

1. A method of recovering raw materials from a polyurethane product, comprising:
(A) providing the polyurethane product, in which the polyurethane product is based on an isocyanate component and a polyol component;
(B) chemolyzing the polyurethane product in the liquid phase
with (i) an aminic chemolysis reagent selected from (a) a primary or secondary organic amine, (b) an amino alcohol having a primary or secondary amino group or (c) a mixture of (a) and (b), and (ii) water in the presence of (iii) a catalyst, at a temperature of 100° C. to 195° C. and at a pressure of 900 mbar_{(abs.)} to 2000 mbar_{(abs.)},
where the mass ratio of (1) aminic chemolysis reagent and water to (2) the polyurethane product on the other hand is in the range from 0.5 to 2.5, and where the mass of water is 3.0% to 22% of the mass of the aminic chemolysis reagent,
to obtain a chemolysis product;
and
(C) working up the chemolysis product to obtain an amine and/or a polyol.

2. The method as claimed in claim 1, in which the polyurethane product, in step (B),
(I) is admixed first with (1) the aminic chemolysis reagent, but not yet with the water, or
(2) the aminic chemolysis reagent and a first portion of the water, and then
(II) the water (1) or a second portion of the water (2) is added to the mixture resulting from (I).

3. The method as claimed in claim 2, in which, in step (II), the water (1) or the second portion of the water (2) is added continuously or in portions such that the temperature of the liquid phase during step (II) differs by a maximum of 20° C. from the temperature of the liquid phase in step (I).

4. The method as claimed in claim 1, in which the aminic chemolysis reagent (a) comprises an aliphatic primary or secondary organic amine, (b) an aliphatic amino alcohol having a primary or secondary amino group or (c) a mixture thereof.

5. The method as claimed in claim 1, in which the catalyst is selected from a hydroxide, a carboxylate, a tin compound, a zinc compound, a carbonate, an orthophosphate, a monohydrogenorthophosphate, a metaphosphate, or a mixture of any two or more thereof.

6. The method as claimed in claim 1, in which step (C) comprises a liquid-liquid extraction with an extractant and phase separation into a first product phase comprising the amine or a salt of the amine and a second product phase comprising the polyol.

7. The method as claimed in claim 6, in which the liquid-liquid extraction is preceded by a distillative separation of the aminic chemolysis reagent from the chemolysis product.

8. The method as claimed in claim 6, in which the isocyanate component comprises tolylene diisocyanate and the extractant comprises (i) an organic solvent selected from a hydrocarbon or a halogen-substituted hydrocarbon and (ii) water.

9. The method as claimed in claim 8, in which the amine is distilled out of the first product phase.

10. The method as claimed in claim 8, in which the organic solvent is selected from cyclohexane, toluene, methylene chloride, chloroform, a chlorinated aromatic hydrocarbon or a mixture of any two or more thereof.

11. The method as claimed in claim 6, in which the isocyanate component comprises methylene diphenylene diisocyanate or a mixture of methylene diphenylene diisocyanate and polymethylene polyphenylene polyisocyanate and the extractant comprises (i) an organic solvent selected from a hydrocarbon or a halogen-substituted hydrocarbon and (ii) hydrochloric acid.

12. The method as claimed in claim 11, in which the organic solvent comprises a halogen-substituted hydrocarbon.

13. The method as claimed in claim 11, in which
(I) the first product phase is extracted with a halogen-substituted hydrocarbon, followed by
(II) phase separation into a first aqueous phase and a first organic phase,
(III) neutralization of the first aqueous phase and phase separation into a second aqueous phase and a second organic phase, and
(IV) distillation and/or stripping of the second organic phase to obtain the amine.

14. The method as claimed in claim 6, in which the second product phase is purified by distillation and/or stripping to obtain the polyol.

15. The method as claimed in claim 1, in which the polyurethane product is a polyurethane foam.
